(19) United States
(12) Patent Application Publication
(10) Pub. No.: US 2005/0160689 A1
(43) Pub. Date: Jul. 28, 2005

(54) Window and window frame structure thereof

(76) Inventor: Chi Ho Song, Kyungki-Do (KR)

Correspondence Address: HARNESS, DICKEY & PIERCE, P.L.C., P.O. BOX 828, BLOOMFIELD HILLS, MI, 48303, US

(21) Appl. No.: 10/504,443

(22) PCT Filed: Feb. 14, 2003
(86) PCT No.: PCT/KR03/00309

(30) Foreign Application Priority Data
Feb. 21, 2002 (KR) 10-2002-0009235

(51) Int. Cl. E06B 1/04; E06B 3/00

(52) U.S. Cl. 52/204.1; 52/204.5

(57) ABSTRACT

Disclosed is a structure of a window frame used in apartments, detached dwellings, apartment units in a private house, residential/commercial combined buildings, or the like. The structure comprises an upper window frame (8) having at least one recess portion fixedly secured to a concrete casting surface of a ceiling (7), a lower window frame (9) having at least one recess portion secured fixed to a concrete casting surface of floor to be flush with the concrete casting surface of the floor, an interior window (2′) having both ends inserted into the upper and lower window frames to form a “ [symbol] ”-shaped cross section, and an exterior window (3′) arranged apart from the interior window at predetermined intervals and having both ends inserted into the upper and lower window frames to form a “ [symbol] ”-shaped cross section.

### TECHNICAL FIELD

The present invention relates to a window frame structure for use in apartments, detached dwellings, apartment units in a private house, residential/commercial combined buildings, or the like, and more particularly, to a structure of a window frame capable of easily enlarging a veranda space as a living room or a room according to the convenience of residents.

### BACKGROUND ART

Recently, residents or appointed tenants enlarge a space of a living room or a room so far as a veranda to more effectively utilize the space, if necessary.

FIG. 1 is a schematic cross-sectional view illustrating the structure of a conventional window frame for a living-room.

Conventional living-room window or ventilation window 1 includes, as shown in FIG. 1, an interior window 2 and an exterior window 3, the interior and exterior windows slidingly moved along a window frame 4. The window frame 4 consists of one support frame secured to a ceiling, a floor and both walls.

The interior window 2 and the exterior window 3 slide from side to side along a pair of guide rails 4a disposed on the ceiling and floor and spaced apart from each other at certain intervals. At that time, the guide rails are outwardly exposed, with they faced to each other.

In the case of a balcony window (not shown) having a parapet, there is at an outermost position a repellent window 6 for blocking off enter of flies, mosquitoes or the like.

However, since the respective guide rails disposed at the ceiling-side supporting portion of the window frame and the floor-side supporting portion of the window frame which support the interior and exterior windows and the repellent window are vertically protruded from the ceiling and the floor, there is a drawback in that the window frames are left as it is or are removed when constructing the veranda to utilize the veranda space.

In particular, since the guide rail disposed at the floor-side supporting portion of the window frame is concavely formed, dusts are collected on the concaved portion of the guide rail, thereby frequently cleaning the guide rail.

Also, since the floor-side window frame is higher than the indoor floor, it is possible to fall over the window frame.

Furthermore, rollers provided to both ends of the interior and exterior windows are directly abutted against the upper and lower guide rails of the window frame when sliding along the guide rails. Accordingly, even if there is a slight eccentricity between the interior and exterior windows and the guide rail when sliding along the curved window frames, it is difficult to open or close the window.

### DISCLOSURE OF THE INVENTION

Therefore, an object of the present invention is to solve the problems involved in the prior art, and to provide a structure of a window frame capable of easily enabling efficient use of a veranda space faced to a living room or room by removing an interior window and an exterior window only.

Another object of the present invention is to prevent dust from being collected in a recessed portion of a guide rail, in the case of a living-room window or ventilation window

Still another object of the present invention is to prevent the possible falling over a stepped portion by eliminating the stepped portion.

Further another object of the invention is to easily open and close a window, in the case of presenting a slight eccentricity between interior and exterior windows and sliding recesses of window frames,

In order to accomplish the above mentioned objects, a structure of a window frame for a living room comprising: an upper window frame having at least one recess portion fixedly secured to a concrete casting surface of a ceiling a lower window frame having at least one recess portion secured fixed to a concrete casting surface of a floor to be flush with the concrete casting surface of the floor; an interior window having both ends inserted into the upper and lower window frames to form a “ [symbol] ”-shaped cross section; and an exterior window arranged apart from the interior window at predetermined intervals and having both ends inserted into the upper and lower window frames to form a “ [symbol] ”-shaped cross section.

It is to be understood that both the foregoing general description and the following detailed description of the present invention are exemplary and explanatory and are intended to provide further explanation of the present invention as claimed.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a schematic cross-sectional view illustrating the structure of a conventional window frame.

FIG. 2 is a schematic cross-sectional view illustrating the structure of a window frame for a living-room according to one preferred embodiment of the present invention.

FIG. 3 is a schematic cross-sectional view illustrating the structure of a window frame for a ventilation window according to one preferred embodiment of the present invention.

FIG. 4 is a plan view illustrating a curved window frame according to an alternative embodiment of the present invention.

FIG. 5 is an enlarged cross-sectional view illustrating a portion of the window frame shown in FIG. 4.

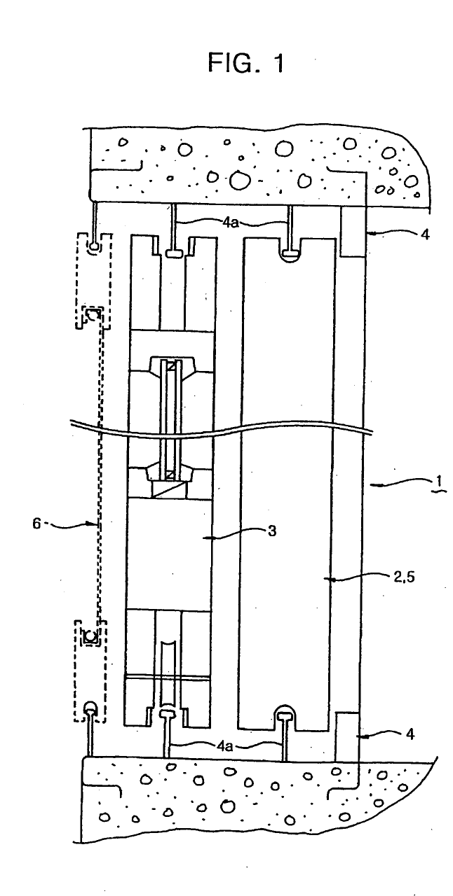

### BEST MODE FOR CARRYING OUT THE INVENTION

Reference will now be made in detail to the preferred embodiments of the present invention; examples of which are illustrated in the accompanying drawings.

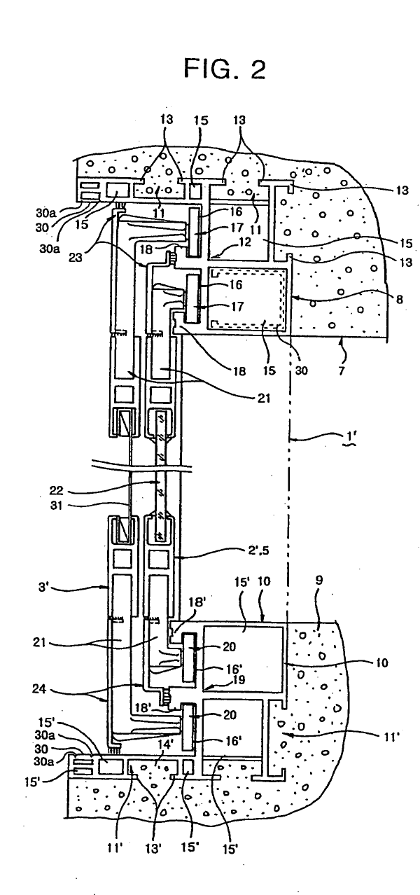

FIG. 2 is a schematic cross-sectional view illustrating the structure of a window frame for a living-room according to one preferred embodiment of the present invention.

The structure of the window frame for living-room window according to the present invention includes, as shown in FIG. 2, an upper window frame 8 having at least one recess portion fixedly secured to a concrete casting surface of a ceiling 7, a lower window frame 9 having at least one recess portion secured fixed to a concrete casting surface of a floor to be flush with the concrete casting surface of the floor, an interior window 2′ having both ends inserted into the upper and lower window frames to form a “ [symbol] ”-shaped cross section, and an exterior window 3′ arranged apart from the interior window at predetermined intervals and having both ends inserted into the upper and lower window frames to form a “ [symbol] ”-shaped cross section. As should be apparent to those skilled in the art, any one of the interior and exterior windows 2′ and 3′ may be replaced by a large-sized window fixedly secured between the upper and lower window frames, and the exterior window 3′ may be replaced by a repellent window 31.

The upper window frame 8 includes at least one fixing portion 11 having at least one recess portion fixedly secured to the concrete casting surface of the ceiling 7, and an upper guide 12 secured to one side of the fixing portion.

The fixing portion 11 has at least one engaging recess 14 with bosses 13 formed on left and right ends thereof, and at least one hollow portion 15 formed around the engaging recess.

The upper guide 12 has sliding recesses 16 spaced apart from each other at one side of the upper guide, and at least one hollow portion 15 formed at the other side of the upper guide. The sliding recess 16 is provided with a restraining protrusion 18 of a desired length protruded upwardly from a lower end of the sliding recess, in which upper rollers 17 fixed to upper ends of the interior and exterior windows 2′ and 3′ are slidably movable along the restraining protrusion 18. Preferably, the upper window frame 8 and the lower window frame 10 are made of PVC or aluminum.

Meanwhile, the lower window frame 10 includes at least one fixing portion 11′ having at least one recess portion fixedly secured to the concrete casting surface of the floor 9, and a lower guide 19 secured to one side of the fixing portion.

The fixing portion 11′ has at least one engaging recess 14′ with bosses 13′ formed on left and right ends thereof, and at least one hollow portion 15′ formed around the engaging recess.

The lower guide 19 has sliding recesses 16′ spaced apart from each other at one side of the lower guide, and at least one hollow portion 15′ formed at the other side of the lower guide. The sliding recess 16′ is provided with a restraining protrusion 18′ of a desired length protruded downwardly from an upper end of the sliding recess, in which lower rollers 20 fixed to lower ends of the interior and exterior windows 2′ and 3′ are slidably movable along the restraining protrusion 18′.

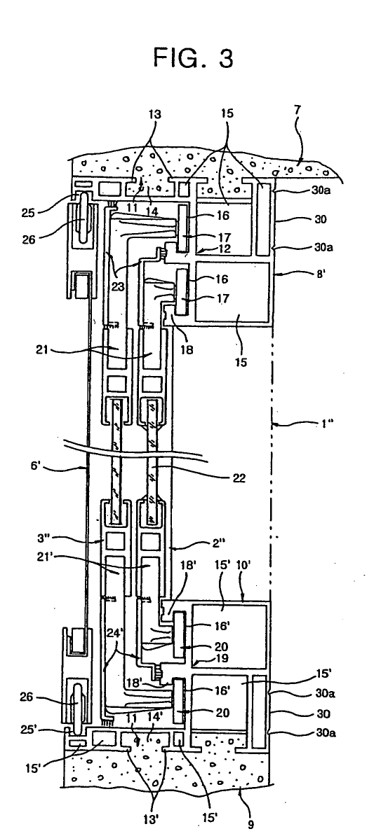

As shown in FIG. 3, the upper window frame 8 and the lower window frame 10 may be provided with another fixing portion, such as fixing portions 11 and 11′, by removing a detachable portion 30 along a score line 30a, if necessary, so that the frames may be more fixedly secured. However, the frames may be secured with nails or other fastening member.

As shown in FIG. 2, the hollow portions 15 and 15′ are provided with a reinforcing member 30 of stainless steel, so that the upper window frames 8 and 8′ and the lower window frames 10 and 10′ are fixedly secured to the concrete casting surface of the ceiling 7 and the concrete casting surface of the floor 9, respectively.

One end of each of the interior window 2′ and the exterior window 3′ is secured, with one end thereof being secured and the other end vertically being extended from a longitudinal axis of the roller supports 21. Each of the roller supports is provided at end thereof with rollers 17 and 20 sliding along the sliding recess 16 of the upper guide 12 and the sliding recess 16′ of the lower guide 19.

A glass 22 is interposed between the respective roller supports 21 of the interior window 2′ and the exterior window 3′, so that inflow of wind, noise or cold/hot air may be blocked.

The respective roller supports 21 of the interior window 2′ includes an upper garnish 23 with one end thereof secured to an outside thereof and the other end thereof closely attached to an external surface of the restraining protrusion. 18 of the upper guide 12, and a lower garnish 24 with one end thereof secured to an outside thereof and the other end thereof closely attached to an external surface of the restraining protrusion 18′ of the lower guide 19.

The respective roller supports 21 of the exterior window 3′ includes an upper garnish 23′ with one end thereof secured to an outside thereof and the other end thereof closely attached to the fixing portion 11 of the upper window frame 8, and a lower garnish 24′ with one end thereof secured to an outside thereof and the other end thereof closely attached to the fixing portion 11′ of the lower window frame 10.

The gap between the interior window and the exterior window is shielded by the upper and lower garnishes 23 and 24 of the interior window 2′ and the upper and lower garnishes 23′ and 24′ of the exterior window 3′, so that inflow of wind, noise or cold/hot air may be blocked.

FIG. 3 is a schematic cross-sectional view illustrating the structure of a window frame for a ventilation window according to one preferred embodiment of the present invention.

The structure of the window frame for a ventilation window according to the present invention includes, as shown in FIG. 3, an upper window frame 8′ having a fixing portion 11 thereof fixedly secured to a concrete casting surface of a ceiling 7, a lower window frame 10′ having a fixing portion 11′ fixedly secured to a concrete casting surface of a floor 9, an interior window 2″ permitting an upper roller 17 of the upper window frame to be inserted into a sliding recess 16 of an upper guide, and a lower roller 20 of the lower window frame 10′ to be inserted into a sliding recess 16′ of a lower guide 19 to form a “ [symbol] ”-shaped cross section, and an exterior window 3″ arranged apart from the interior window at predetermined intervals and having an upper roller 17 and a lower roller 20 inserted into the upper and lower window frames 8′ and 10′, respectively, to form a “ [symbol] ”-shaped cross section

The upper window frame 8′ and the lower window frame 10′ may be provided with another fixing portion, such as fixing portions 11 and 11′, by removing a detachable portion 30 along a score line 30a, if necessary, so that the frames may be more fixedly secured. However, the frames may be secured with nails or other fastening member.

A repellent window 31 is disposed at a given distance from an outside of the exterior window 3″. An upper portion of the repellent window is slidingly inserted into a recess 25 of the upper window frame 8′, and a lower portion thereof is slidingly inserted into a recess 25′ of the lower window frame 10′.

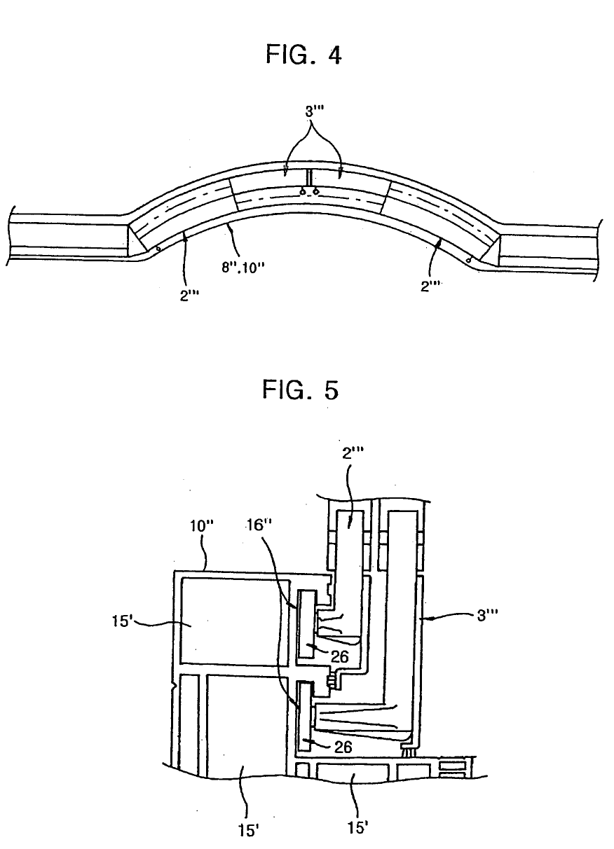

According to the structure of the window frame for the living-room window or ventilation window, as shown in FIGS. 4 and 5, the upper window frame 8″ and the lower window frame 10″ are spaced apart from to each other at a given distance, and are outwardly bent in a certain curvature. An interior window 2′″ and an exterior window 3′″ are outwardly bent in the same curvature as those of the upper and lower window frames, with they being spaced apart from each other. The interior and exterior windows may be movable along the sliding recesses 16″ of the upper and lower window frames 8″ and 10″ with the rollers 26 slidingly moved along the recesses.

The respective sliding recesses 16″ may be adapted to have a size larger than an outer diameter of the roller 26, such that the interior window 2′″ and the exterior window 3′″ may smoothly move along the upper and lower window frames 8″ and 10″, even if there is a slight eccentricity between the upper and lower window frames 8″ and 10″ and the interior and exterior windows 2′″ and 3′″.

The assembly and operation of the window frame according to the present invention will now be described.

The upper window frame 8 and the lower window frame 10 are installed to the ceiling 7 and the floor 9 when forming a concrete slab.

At that time, the respective fixing portions 11 and 11′ of the upper and lower window frames 8 and 10 is fixed by the concrete poured into the respective engaging recesses 14 and 14′, and is additionally fixed by the bosses 13 and 13′ protruded from front ends of the engaging recesses.

Therefore, the upper guide 12 of the upper window frame 8 and the lower guide 19 of the lower window frame 10 are supported by the fixing portions 11 and 11′, thereby slidingly supporting the respective rollers 17 and 20 of the interior and exterior windows 2′ and 3′.

Specifically, the upper roller 17 secured by the upper roller support 21 is slidingly supported within the sliding recess 16, with the roller enclosed by the restraining protrusion 18 of the upper guide 12. Also, the lower roller 20 secured by the lower roller support 21 is slidingly supported within the sliding recess 16′, with the roller enclosed by the restraining protrusion 18′ of the lower guide 19.

Furthermore, the respective upper roller supports 21 of the interior and exterior windows 2′ and 3′ is provided with the upper garnish 23, and the respective lower roller supports 21 is provided with the lower garnish 24, so that inflow of wind, noise or cold/hot air may be blocked.

In the case of the ventilation window 1″, as shown in FIG. 3, it can be assembled as the same method as that of the living-room window 1′, except that the upper window frame 8′ and the lower window frame 10′ are contacted to the ceiling 7 and the floor 9, respectively.

In addition, in the case of providing the upper window frame 8′ and the lower window frame 10′ with a curved portion of a desired curvature, the respective roller 26 of the curved interior and exterior windows 2′″ and 3′″ may smoothly move along the respective sliding recesses 16″ within a certain range of an allowable tolerance.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers all modifications and variations of this invention that come within the scope of the appended claims and their equivalents.

Industrial Applicability

With the above description, the present invention can enable efficient use of a veranda space faced to a living room by removing the interior window and the exterior window only.

In addition, in the case of the living-room window or ventilation window, dust may not be collected in the recessed portion of a guide rail.

The stepped portion provided by the conventional window frame is eliminated by the present invention, and thus it can prevent the possible falling over the stepped portion.

Furthermore, in the case of presenting a slight eccentricity between the interior and exterior windows and the sliding recesses of the window frames, the open and close of the window may be smoothly achieved.

1. A structure of a window frame for a living room, comprising:
an upper window frame 8 having at least one recess portion fixedly secured to a concrete casting surface of a ceiling 7;
a lower window frame 9 having at least one recess portion secured fixed to a concrete casting surface of a floor to be flush with the concrete casting surface of the floor;
an interior window 2′ having both ends inserted into the upper and lower window frames to form a “ [symbol] ”-shaped cross section; and
an exterior window 3′ arranged apart from the interior window at predetermined intervals and having both ends inserted into the upper and lower window frames to form a “ [symbol] ”-shaped cross section

2. The structure as claimed in claim 1, wherein the upper window frame 8 includes at least one fixing portion 11 having at least one recess portion fixedly secured to the concrete casting surface of the ceiling 7, and an upper guide 12 secured to one side of the fixing portion;
wherein the fixing portion 11 has at least one engaging recess 14 with bosses 13 formed on left and right ends thereof and at least one hollow portion 15 formed around the engaging recess;
the upper guide 12 has sliding recesses 16 spaced apart from each other at one side of the upper guide, and at least one hollow portion 15 formed at the other side of the upper guide; and
the sliding recess 16 is provided with a restraining protrusion 18 of a predetermined length protruded upwardly from a lower end of the sliding recess, in which upper rollers 17 fixed to upper ends of the interior and exterior windows 2′ and 3′ are slidably movable along the restraining protrusion 18.

3. The structure as claimed in claim 1, wherein the lower window frame 10 includes at least one fixing portion 11′ having at least one recess portion fixedly secured to the concrete casting surface of the floor 9, and a lower guide 19 secured to one side of the fixing portion;
wherein the fixing portion 11′ has at least one engaging recess 14′ with bosses 13′ formed on left and right ends thereof, and at least one hollow portion 15′ formed around the engaging recess;
the lower guide. 19 has sliding recesses 16′ spaced apart from each other at one side of the lower guide, and at least one hollow portion 15′ formed at the other side of the lower guide; and
the sliding recess 16′ is provided with a restraining protrusion 18′ of a predetermined length protruded downwardly from an upper end of the sliding recess, in which lower rollers 20 fixed to lower ends of the interior and exterior windows 2′ and 3′ are slidably movable along the restraining protrusion 18′.

4. The structure as claimed in claim 1, wherein any end of each of the interior window 2′ and the exterior window 3′ is secured, one end being secured and the other end thereof being vertically extended from a longitudinal axis of roller supports 21, in which each of the roller supports is provided at end thereof with rollers 17 and. 20 sliding along the sliding recess 16 of the upper guide 12 and the sliding recess 16′ of the lower guide 19.

5. The structure as claimed in claim 4, wherein the respective roller support 21 of the interior window 2′ includes an upper garnish 23 with one end thereof secured to an outside thereof and the other end thereof closely attached to an external surface of the restraining protrusion 18 of the upper guide 12, and a lower garnish 24 with one end thereof secured to an outside thereof and the other end thereof closely attached to an external surface of the restraining protrusion 18′ of the lower guide 19; and
wherein the respective roller support 21 of the exterior window 3′ includes an upper garnish 23′ with one end thereof secured to an outside thereof and the other end thereof closely attached to the fixing portion 11 of the upper window frame 8, and a lower garnish 24′ with one end thereof secured to an outside thereof and the other end thereof closely attached to the fixing portion 11′ of the lower window frame 10.

6. The structure as claimed in claim 1, wherein a repellent window is disposed at predetermined intervals from an outside of the exterior window 3′, of which an upper portion is slidingly inserted into a recess 25 of the upper window frame 8 and a lower portion is slidingly inserted into a recess 25′ of the lower window frame 10.

7. A structure of a window frame for a ventilation window, comprising:
an upper window frame 8′ with a fixing portion 11 thereof fixedly secured to a concrete casting surface of a ceiling 7;
a lower window frame 10′ with a fixing portion 11′ fixedly secured to a concrete casting surface of a floor 9;
an interior window 2″ permitting an upper roller 17 of the upper window frame to be inserted into a sliding recess 16 of an upper guide and a lower roller 20 of the lower window frame 10′ to be inserted into a sliding recess 16′ of a lower guide 19 to form a “ [symbol] ”-shaped cross section; and
an exterior window 3″ arranged apart from the interior window at predetermined intervals and having an upper roller 17 and a lower roller 20 inserted into the upper and lower window frames 8′ and 10′, respectively, to form a “ [symbol] ”-shaped cross section.
